(19) United States
(12) Patent Application Publication
(10) Pub. No.: US 2010/0091091 A1
(43) Pub. Date: Apr. 15, 2010

(54) BROADCAST DISPLAY APPARATUS AND METHOD FOR DISPLAYING TWO-DIMENSIONAL IMAGE THEREOF

(75) Inventor: Jae-won Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/498,001

(22) Filed: Jul. 6, 2009

(30) Foreign Application Priority Data
Oct. 10, 2008 (KR) 10-2008-0099743

(51) Int. Cl. H04N 13/04; H04N 5/45

(52) U.S. Cl. 348/42; 348/565; 348/E05.112; 348/E13.075

(57) ABSTRACT

A broadcast display apparatus and a two dimensional (2D) image display method of the broadcast display apparatus are provided. The 2D image display method includes selecting a 2D display mode; generating a 2D image using at least one of a left image and a right image of a three dimensional (3D) image; and displaying the 2D image.

### CROSS-REFERENCE TO RELATED APPLICATIONS

This application claims priority from Korean Patent Application No. 10-2008-0099743, filed on Oct. 10, 2008, in the Korean Intellectual Property Office, the disclosure of which is incorporated herein by reference in its entirety.

### BACKGROUND OF THE INVENTION

1. Field of the Invention

Apparatuses and methods consistent with the present invention relate to providing a broadcast display apparatus and displaying a two dimensional (2D) image, and more particularly, to providing a broadcast display apparatus and method for converting a three-dimensional (3D) image into a 2D image and displaying the converted 2D image.

2. Description of the Related Art

3D image technologies provide a 3D image using a left-eye image (hereafter “left image”) and a right-eye image (hereafter “right image”), and are applied in various fields, for example information communication, broadcasting, medical treatment, education and training, military, game, animation, virtual reality, computer-aided design (CAD) and industrial technology.

Recently, broadcast display apparatuses, such as televisions (TVs), are also able to provide 3D images which viewers can view 3D images using special glasses.

However, when a broadcast display apparatus displays a 3D image, there may be a great number of viewers but not enough special glasses. In this situation, if the broadcast display apparatus continues to display the 3D image, it is impossible for viewers without special glasses to view the displayed 3D image.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a broadcast display apparatus capable of converting an input 3D image into a 2D image and displaying the converted 2D image in order to prevent degradation of image quality, and a 2D image display method of the broadcast display apparatus.

According to an aspect of the present invention, there is provided a 2D image display method of a broadcast display apparatus, the method comprising selecting a 2D display mode, generating a 2D image using at least one of an input left image and right image, and displaying the generated 2D image.

The 2D image may be an intermediate image obtained by combining the left image and the right image.

The method may further comprise selecting a picture-in-picture (PIP) mode to display a single main screen and one or more sub-screens. If a 3D image comprising a left image and a right image is displayed on the main screen in the PIP mode, a 2D image may be generated and displayed on the main screen using the 3D image appearing on the main screen.

If a 3D image comprising a left image and a right image is displayed on the one or more sub-screens, a 2D image may be generated on the one or more sub-screens using the 3D image appearing on the one or more sub-screens.

The left image and the right image may be moving images.

According to another aspect of the present invention, there is provided a broadcast display apparatus comprising a user selection unit through which a 2D display mode is selected, a processor which generates a 2D image using at least one of an input left image and right image, and a display unit which displays the generated 2D image.

When a PIP mode to display a single main screen and one or more sub-screens is selected by the user selection unit, if a 3D image comprising a left image and a right image is displayed on one of the main screen and the one or more sub-screens, the processor may generate and display a 2D image using the 3D image.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 illustrates a 3D image system which provides a 3D image according to an exemplary embodiment of the present invention;

FIG. 2 is a block diagram of a broadcast display apparatus shown in FIG. 1, according to an exemplary embodiment of the present invention;

FIG. 3A exemplary illustrates a left image and a right image displayed on a display unit of the broadcast display apparatus shown in FIG. 1, according to an exemplary embodiment of the present invention;

FIG. 3B is a view to explain an operational principle for generating a 2D image, according to an exemplary embodiment of the present invention;

FIGS. 4A to 4C exemplary illustrate images appearing on the display unit when a currently viewed 3D image is converted into a 2D image, according to an exemplary embodiment of the present invention; and

FIG. 5 is a flowchart for explaining a 2D image display method of the broadcast display apparatus shown in FIG. 1, according to an exemplary embodiment of the present invention.

### DETAILED DESCRIPTION OF EXEMPLARY EMBODIMENTS

Certain exemplary embodiments of the present invention will now be described in greater detail with reference to the accompanying drawings.

In the following description, the same drawing reference numerals are used for the same elements even in different drawings. The matters defined in the description, such as detailed construction and elements, are provided to assist in a comprehensive understanding of the invention. Thus, it is apparent that the exemplary embodiments of the present invention can be carried out without those specifically defined matters. Also, well-known functions or constructions are not described in detail since they would obscure the invention with unnecessary detail.

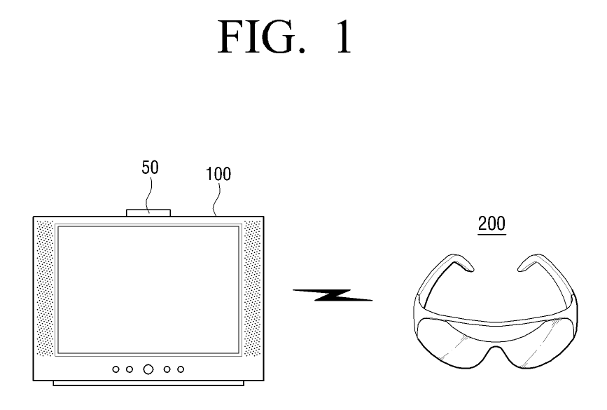

FIG. 1 illustrates a 3D image system which provides a 3D image according to an exemplary embodiment of the present invention.

The 3D image system shown in FIG. 1 comprises a broadcast display apparatus 100 and shutter glasses 200 through which a user can view a 3D image.

The broadcast display apparatus 100 is able to provide a 3D image, convert the 3D image into a two dimensional (2D) image and display the converted 2D image. A 3D image may be displayed by a left image and a right image, which are captured by at least two cameras, and may be a moving image. A 2D image refers to a moving image of a planar view.

The broadcast display apparatus 100 generates a left image and a right image, and outputs the left image and the right image alternately in regular intervals. Accordingly, the left image and the right image may be displayed alternately on a screen of the broadcast display apparatus 100. Additionally, the broadcast display apparatus 100 generates a synchronizing signal synchronized with the left image and the right image, and transfers the synchronizing signal to an infrared (IR) transmitter 50. The IR transmitter 50 transmits the synchronizing signal to the shutter glasses 200 using an infrared transmission method.

The shutter glasses 200 receive the left image and right image alternately from the broadcast display apparatus 100, and enable a user to view a 3D image.

The IR transmitter 50 may be integrated into the broadcast display apparatus 100. In this case, the shutter glasses 200 receive the synchronizing signal from the broadcast display apparatus 100, match the synchronization between the left image and right image displayed on the broadcast display apparatus 100, and open the left glass and the right glass alternately. Accordingly, a user wearing the shutter glasses 200 can view a 3D image.

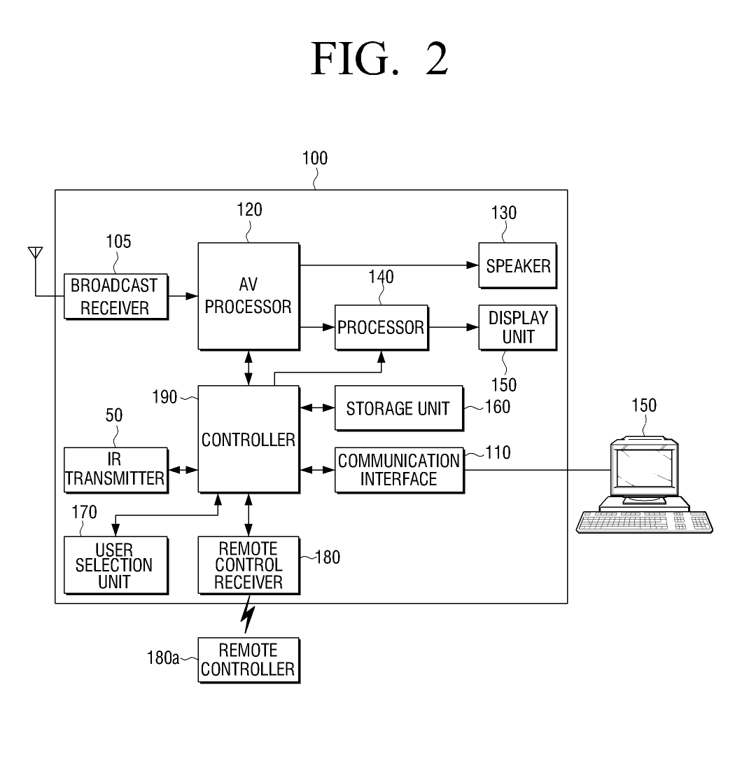

FIG. 2 is a block diagram of the broadcast display apparatus 100 shown in FIG. 1.

Referring to FIGS. 1 and 2, the broadcast display apparatus 100 comprises a broadcast receiver 105, a communication interface 110, an audio/video (AV) processor 120, a speaker 130, a processor 140, a display unit 150, a storage unit 160, a user selection unit 170, a remote control receiver 180 and a controller 190.

The broadcast receiver 105 receives a broadcast signal from a broadcasting station or a satellite via a wired or wireless connection, and demodulates the received broadcast signal. The broadcast signal may comprise a data signal comprising news information, weather reports and stock market information. If a broadcasting station or a satellite provides a 3D image, the broadcast receiver 105 may receive a signal for the 3D image.

The communication interface 110 provides a terminal connected to an external apparatus 150 via a wired and wireless communication network (not shown). Accordingly, the communication interface 110 receives a 3D image having a right image and a left image from the connected external apparatus 150. The external apparatus 150 may be implemented as a personal computer (PC), a laptop computer, a digital camera or other image transmission apparatuses.

Additionally, the communication interface 110 receives various web pages from websites via a communication network (not shown). Accordingly, the broadcast display apparatus 100 may provide Internet Protocol television (IPTV) services. IPTV services refer to bi-directional TV services provided using high-speed Internet access networks.

The AV processor 120 performs signal processing, such as video decoding, video scaling, and audio decoding, of audio and video signals output from the broadcast receiver 105 or a 3D image output from the communication interface 110. Additionally, the AV processor 120 outputs the video signal to the processor 140 and the audio signal to the speaker 130.

In order to store the received video and audio signals in the storage unit 160, the AV processor 120 outputs the video and audio in a compressed format to the storage unit 160.

The speaker 130 amplifies the audio output from the AV processor 120, and outputs the amplified audio outside.

The processor 140 generates various menus to provide a user with a graphical user interface (GUI) screen or an on-screen-display (OSD) screen. The processor 140 superimposes the menus over the video signal output from the AV processor 120, and outputs the superimposed video to the display unit 150.

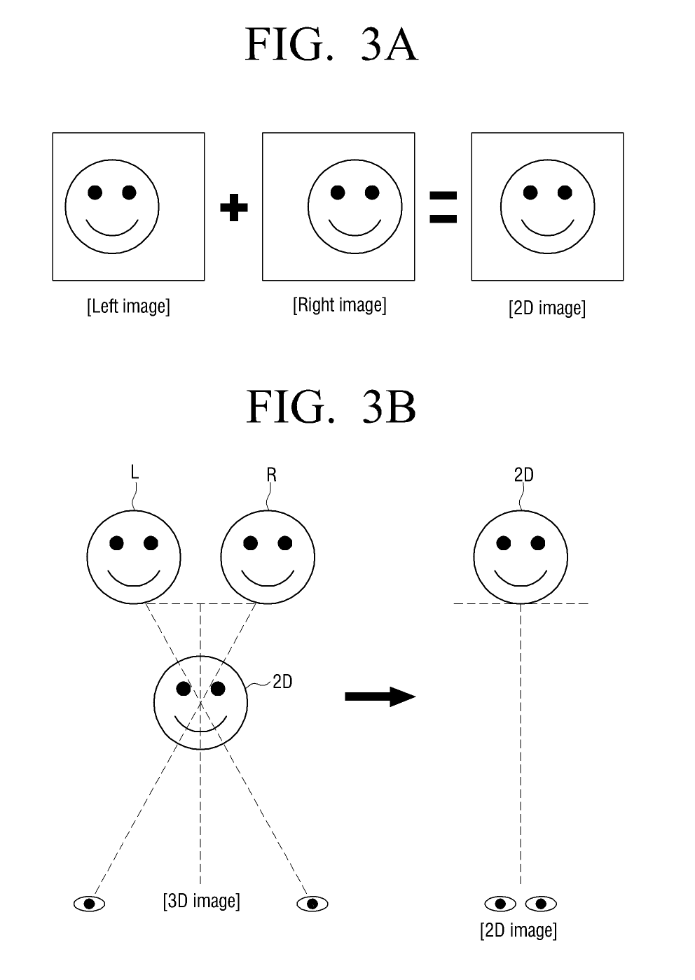

Additionally, the processor 140 generates a 2D image using a 3D image. In more detail, the processor 140 generates a 2D image using at least one of the left image and the right image of the 3D image. If the current mode of the broadcast display apparatus 100 is set to be a first display mode by a developer or user, the processor 140 may combine or synthesize the left image with the right image and generate a 2D image, as shown in FIG. 3A, and then output the 2D image to the display unit 150.

FIG. 3A exemplary illustrates the left image and the right image constituting the 3D image, and the 2D image when the left image and the right image are combined or synthesized, and FIG. 3B is a view to explain an operational principle for generating a 2D image.

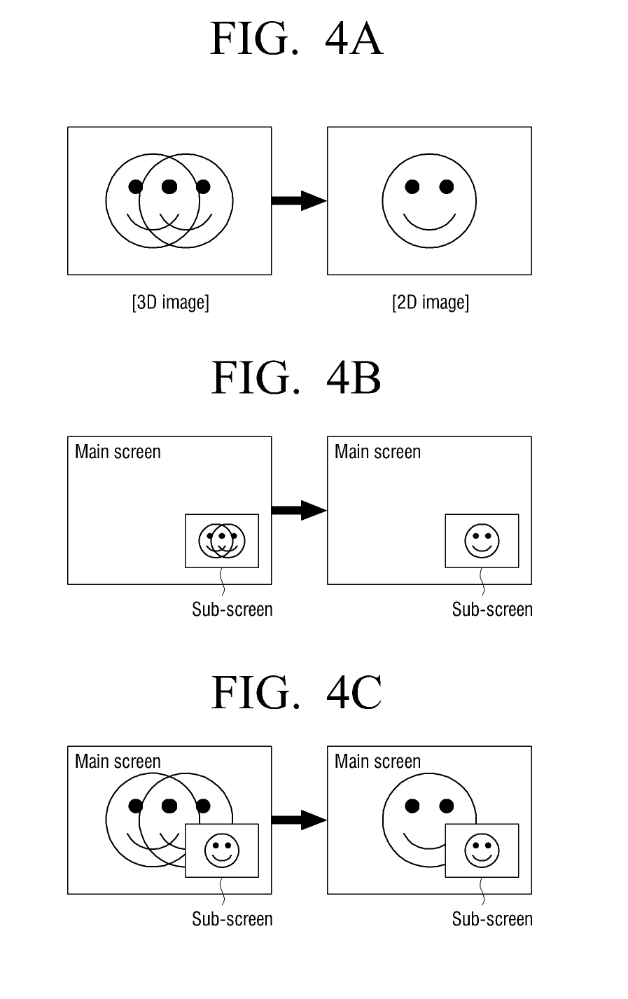

As shown in FIG. 3B, a 2D image is an intermediate image obtained by combining a left image L and a right image R of a 3D image. In more detail, after the left image L and the right image R are combined, portions of the combined image which lean either to the right or left are deleted to obtain an intermediate image, namely a 2D image. Accordingly, the 2D image may be displayed on the center of the screen rather than leaning either to the right or left, when a user views the 3D image from the front. The intermediate image, namely the 2D image, may be displayed on the display unit 150 via a line such as a low voltage differential signal (LVDS) cable. FIG. 4A exemplary illustrates images displayed on the display unit 150 when a currently viewed 3D image is converted into a 2D image.

If the current mode of the broadcast display apparatus 100 is set to be a second display mode by a developer or user, the processor 140 selects either the left image or the right image. For example, if the processor 140 selects the left image, the selected left image may be output to the display unit 150.

If the user selects a picture-in-picture (PIP) mode using the user selection unit 170, the processor 140 superimposes an image appearing on a sub-screen over an image appearing on a main screen, and outputs the superimposed image to the display unit 150.

When a broadcast signal is displayed on a main screen and a 3D image is displayed on a sub-screen, as shown in FIG. 4B, if a user sets the first display mode or the second display mode, the processor 140 may convert the 3D image on the sub-screen into a 2D image using the above-described method according to the set mode. In this situation, if the 3D image is not converted into the 2D image and if the user wears the shutter glasses 200, the user may feel as if the main screen flickers, but if the user does not wear the shutter glasses 200, the user may feel as if the sub-screen repeatedly moves to the left or right. To avoid such a phenomenon, there is a need to convert the 3D image into the 2D image as provided in this exemplary embodiment. Thus, it is possible for a large number of users to view images without distortion of image quality even when they do not wear the shutter glasses 200.

Since the shutter glasses 200 alternately darken the view for the left or right eye, the user feels as if the main screen flickers. If the frame rate which supports the entire image is 60 Hz, a left eye and the right eye may view an image of 30 Hz only, and accordingly the user may feel as if the image at 30 Hz flickers. More accurately, if the image on the main screen flickers, the frame rate may be reduced. In this situation, the broadcast display apparatus 100 does not provide any function to increase the frame rate, and accordingly the 3D image on the sub-screen in the PIP mode needs to be converted into the 2D image so as to eliminate flickering of the main screen.

Additionally, when a 3D image is displayed on a main screen and a broadcast signal is displayed on a sub-screen, as shown in FIG. 4C, if a user sets the first display mode or the second display mode, the processor 140 may convert the 3D image on the main screen into a 2D image using the above-described method according to the set mode. In this situation, if the 3D image is not converted into the 2D image and if the user wears the shutter glasses 200, the user may feel as if the sub-screen flickers, but if the user does not wear the shutter glasses 200, the user may feel as if the 3D image on the main screen repeatedly moves to the left or right. Accordingly, it is possible to convert the 3D image on the main screen into the 2D image in order to avoid flickering of the sub-screen, as provided in this exemplary embodiment.

The display unit 150 displays the left image or the right image output from the processor 140. The display unit 150 may be implemented as a liquid crystal display (LCD) panel, a plasma display panel (PDP) or other display devices.

The storage unit 160 stores image signals, multimedia contents, or data information which are received from the broadcast receiver 105 or the communication interface 110. The storage unit 160 may be implemented as a hard disc, a nonvolatile memory or another storage medium.

Additionally, the storage unit 160 stores a display mode set by a user. The display mode comprises a 2D view mode and a 3D view mode. The 2D view mode may be implemented by a first display mode and a second display mode.

The 2D view mode enables a user to view a 3D image in the form of a 2D image when the 3D image is received via a currently viewed channel. The 3D view mode enables a user to view a 3D image when the 3D image is received via a currently viewed channel.

The first display mode combines a left image and a right image of a 3D image, create an intermediate image and display the intermediate image as a 2D image, when a user desires to view the 3D image in the form of a 2D image, that is, when the 2D view mode is set. The second display mode generates a 2D image using one of a left image and a right image of a 3D image and displays the 2D image, when a user desires to view the 3D image in the form of a 2D image.

The user selection unit 170 functions as an interface, which receives user commands and transfers the user commands to the controller 190. The user selection unit 170 requests display of a menu containing a plurality of items, and selects a single item from the displayed menu. If the broadcast display apparatus 100 is set to a widget mode, each of the plurality of items may act as a widget.

The remote control receiver 180 receives user operation from a remote controller 180a, and transmits the user operation to the controller 190. The remote controller 180a performs substantially the same function as the user selection unit 170.

The controller 190 controls the entire operation of the broadcast display apparatus 100 according to the user commands output from the user selection unit 170 or remote controller 180a. Various programs required to control the broadcast display apparatus 100 are stored in the storage unit 160. Additionally, the controller 190 controls the processor 140 so that an image corresponding to the user command is displayed on the display unit 150, as shown in FIGS. 3A, 3B and 4A to 4C.

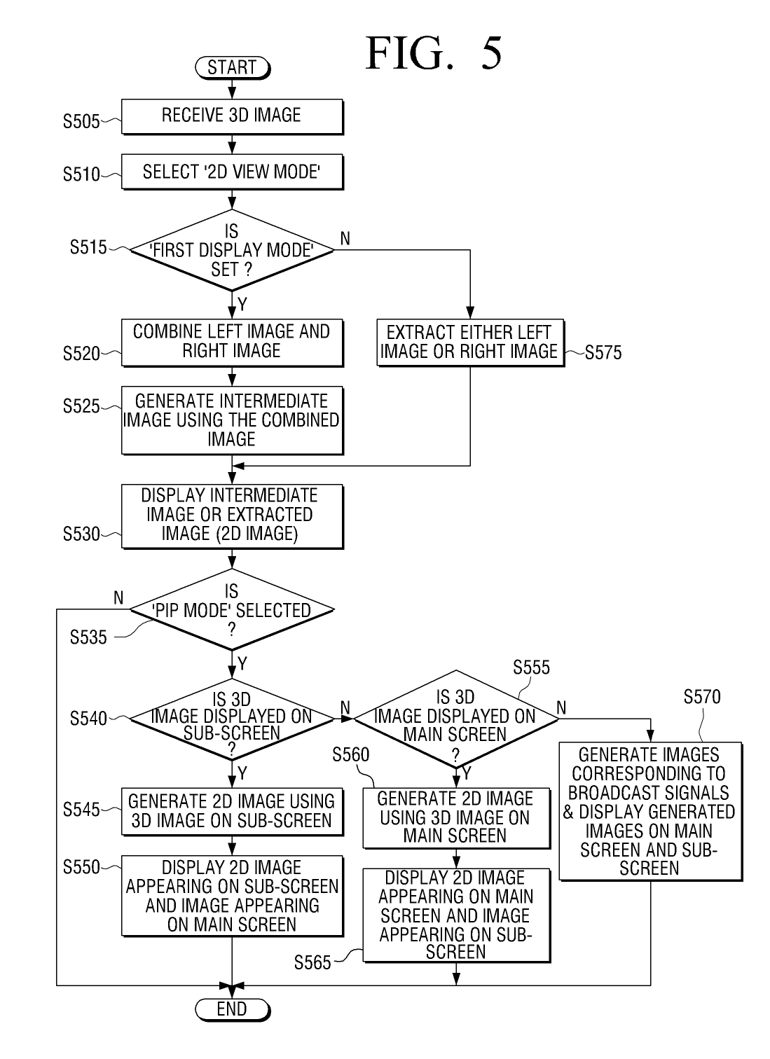

FIG. 5 is a flowchart explaining a 2D image display method of the broadcast display apparatus 100, according to an exemplary embodiment.

Referring to FIGS. 1 to 5, a 3D image is received via the broadcast receiver 105 or the communication interface 110, and displayed on the display unit 150 (S505). The 3D image comprises a left image and a right image.

If a user selects the 2D view mode using the user selection unit 170 (S510), the controller 190 checks the storage unit 160 to know a currently set display mode (S515).

If it is determined that the broadcast display apparatus 100 is in the first display mode in operation S515, the controller 190 controls the processor 140 to combine the left image with the right image (S520), to generate an intermediate image based on the combined image and to output the intermediate image to the display unit 150 (S525). The intermediate image refers to a 2D image acquired from the 3D image, as described above.

The display unit 150 displays the intermediate image received from the processor 140 in the form of a 2D image (S530).

If the user selects the PIP mode (S535), the controller 190 determines whether a 3D image is received via a channel corresponding to the sub-screen (S540). An image received by the broadcast receiver 105 or the communication interface 110 comprises information enabling the controller 190 to distinguish a 2D image from a 3D image.

If a 3D image is displayed on the sub-screen (S540-Y), the controller 190 controls the processor 140 to generate a 2D image based on the 3D image on the sub-screen (S545). In operation S545, the processor 140 generates a 2D image according to the set mode between the first display mode and the second display mode.

The controller 190 controls the processor 140 and the display unit 150 to superimpose the 2D image appearing on the sub-screen over an image appearing on the main screen and to display the superimposed image (S550).

Alternatively, if a 3D image is displayed on the main screen (S555), the controller 190 controls the processor 140 to generate a 2D image based on the 3D image on the main screen (S560). In operation S560, the processor 140 generates a 2D image according to the set mode between the first display mode and the second display mode.

The controller 190 controls the processor 140 and the display unit 150 to superimpose an image appearing on the sub-screen over the 2D image appearing on the main screen and to display the superimposed image (S565).

Additionally, if general broadcast signals are received (S555-N), the controller 190 controls the processor 140 and the display unit 150 to generate images corresponding to the received broadcast signals and display the images on the main screen and the sub-screen (S570).

If it is determined that the broadcast display apparatus 100 is in the second display mode in operation S515, the controller 190 controls the processor 140 to extract either the left image or the right image from the 3D image (S575), and display the extracted image as a 2D image (S530).

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A two-dimensional (2D) image display method using a broadcast display apparatus, the method comprising:
selecting a 2D view mode;
generating a 2D image, according to the 2D view mode, using at least one of a left-eye image and a right-eye image of an input three-dimensional (3D) image; and
displaying the 2D image.

2. The method as claimed in claim 1, wherein the 2D image is generated by combining the left-eye image and the right-eye image of the input 3D image and generating an intermediate image which is the 2D image, or by selecting one of the left-eye image and the right-eye image of the input 3D image as the 2D image.

3. The method as claimed in claim 1, further comprising:
selecting a picture-in-picture (PIP) mode to display a main screen and a sub-screen;
determining which image among an image displayed on the main screen and an image displayed on the sub-screen is 3D; and
converting the determined image to another 2D image.

4. The method as claimed in claim 3, wherein the determined 3D image is converted to the other 2D image by combining a left-eye image and a right-eye image of the determined 3D image, or selecting one of the left-eye image and the right-eye image of the determined 3D image.

5. The method as claimed in claim 1, wherein each of the left-eye image and the right-eye image is a moving image.

6. The method as claimed in claim 1, further comprising receiving the input 3D image and displaying the input 3D image that are performed before the selecting the 2D view mode.

7. A broadcast display apparatus comprising:
a selection unit which selects a two-dimensional (2D) view mode;
a processor which generates a 2D image, according to the 2D view mode, using at least one of a left-eye image and a right-eye image of an input three-dimensional (3D) image;
a controller which controls the processor to generate the 2D image; and
a display unit which displays the 2D image.

8. The broadcast display apparatus as claimed in claim 7, wherein the controller controls the processor to generate the 2D image by combining the left-eye image and the right-eye image of the input 3D image and generate an intermediate image which is the 2D image, or by selecting one of the left-eye image and the right-eye image of the input 3D image as the 2D image.

9. The broadcast display apparatus as claimed in claim 7, wherein the selection unit is configured to select a picture-in-picture mode which displays a main screen and a sub-screen, and
wherein, if the PIP mode is selected by the user selection unit, the controller determines which image among an image displayed on the main screen and an image displayed on the sub-screen is 3D, and controls the process to convert the determined image to another 2D image.

10. The broadcast display apparatus as claimed in claim 9, the controller controls the processor to convert the determined image to the other 2D image by combining a left-eye image and a right-eye image of the determined 3D image, or selecting one of the left-eye image and the right-eye image of the determined 3D image.

11. The broadcast display apparatus as claimed in claim 7, wherein each of the left image and the right image is a moving image.

12. The broadcast display apparatus as claimed in claim 7, wherein the display unit is configured to display the input 3D image before the user selection unit selects the 2D view mode.
